(19) United States
(12) Patent Application Publication
(10) Pub. No.: US 2004/0013502 A1
(43) Pub. Date: Jan. 22, 2004

(54) Storage disk organizer

(76) Inventor: Mickle Chiou, Chungli City (TW)

Correspondence Address: Jason Z. Lin, Supreme Patent Services, Post Office Box 2339, Saratoga, CA, 95070-0339, US

(21) Appl. No.: 10/199,417

(22) Filed: Jul. 19, 2002

(51) Int. Cl. B65G 1/00

(52) U.S. Cl. 414/280

(57) ABSTRACT

A disk organizer includes a cabinet defining a number of storage cells each of which is associated with an electrically controlled magnetic device. A disk enclosure is movably received in each of the storage cells. The disk enclosure receives and accommodates a storage disk therein. A magnet is mounted to the enclosure and corresponds to the electrically controlled magnetic device of the cell associated with the enclosure. A controller system comprised of a computer equipped with storage memory and a user interface, is connected to the electrically controlled magnetic devices for selectively energizing the electrically controlled magnetic device to generate magnetic attraction and expulsion for the magnet to selectively move the disk enclosure in and out of the associated storage cell of the cabinet. Information and index of the disks stored in the cabinet is recorded in the computer storage memory whereby a user may search and access the disks by means of the user interface of the computer. The user interface can be a keyboard, a touch panel or a mouse.

### FIELD OF THE INVENTION

The present invention relates generally to an organizer for computer disks, such as compact disk (CD) and visual compact disk (VCD), and in particular to a storage disk organizer for automatically depositing and withdrawing the selected disks.

### BACKGROUND OF THE INVENTION

Computer data or information is commonly stored in storage disks, such as magnetic disks and compact disks (CDs). For most computer users, an organizer for organizing a number of disks is a quite handy tool. However, most of the disk organizers are constructed in the form of a small bin in which partitions are made for forming a number of “flat” spaces each accommodating a disk. The conventional designs of the disk organizer have disadvantages as follows:

(1) The disks that are deposited in the fiat spaces show only their side surfaces that are very thin. Such a small dimension does not allow attachment of an index label, causing certain problems to the user in searching disks.

(2) Each flat space of the storage bin must have a width substantially greater than the width of the storage disks for easy movement of the disk in and out of the bin.

(3) Besides the additional space required in the width direction, the dimension between two partitions that defines the flat space for accommodating one single disk must be substantially increased for user's access of the disk deposited in the bin. Apparently, the actual overall size of the disk bin is much larger than what is really needed for storage of the disks.

(4) Although the dimension between two partitions is substantially increased to accommodate user's finger for accessing the disk deposited in the flat space between the partitions, the user's finger inevitably contact and is thus interfered with by the disks located above and below the one that is to be accessed.

(5) Although some of the conventional disk organizers are provided with disk retrieval mechanisms for overcoming some of the above-mentioned deficiencies, such disk retrieval mechanisms occupy a substantial amount of space, which increases the overall size of the disk organizer.

In view of the above deficiencies of the conventional disk storage bins, it is desired to have an automatic disk organizer for overcoming the above problems.

### SUMMARY OF THE INVENTION

An object of the present invention is to provide a disk organizer having a compact size for organizing computer disks.

Another object of the present invention is to provide an automatic disk organizer comprising an automatic disk retrieval system controlled by a computer or a microprocessor-based device for automatic retrieval of desired disks from the disk organizer.

A further object of the present invention is to provide a disk organizer that automatically retrieves desired disks and interference caused by adjacent disks in retrieving the desired disks is completely eliminated.

Yet a further object of the present invention is to provide an automatic disk organizer wherein access of disks is enhanced by a computer or microprocessor-based controller, which helps and simplifies search of desired disks.

To achieve the above objects, in accordance with the present invention, there is provided a disk organizer comprising a cabinet defining a number of storage cells each of which is associated with an electrically controlled magnetic device. A disk enclosure is movably received in each of the storage cells. The disk enclosure receives and accommodates a storage disk therein. A magnet is mounted to the enclosure and corresponds to the electrically controlled magnetic device of the cell associated with the enclosure. A controller system comprised of a computer equipped with storage memory and a user interface, is connected to the electrically controlled magnetic devices for selectively energizing the electrically controlled magnetic device to generate magnetic attraction and expulsion for the magnet to selectively move the disk enclosure in and out of the associated storage cell of the cabinet. Information and index of the disks stored in the cabinet is recorded in the computer storage memory whereby a user may search and access the disks by means of the user interface of the computer. The user interface can be a keyboard, a touch panel or a mouse.

### BRIEF DESCRIPTION OF THE DRAWINGS

The present invention will be apparent to those skilled in the art by reading the following description of a preferred embodiment thereof, with reference to the attached drawings, in which:

FIG. 1 is an exploded view of a disk organizer constructed in accordance with the present invention; and

FIG. 2 is a schematic view of the disk organizer connected to a controller system.

### DETAILED DESCRIPTION OF THE INVENTION

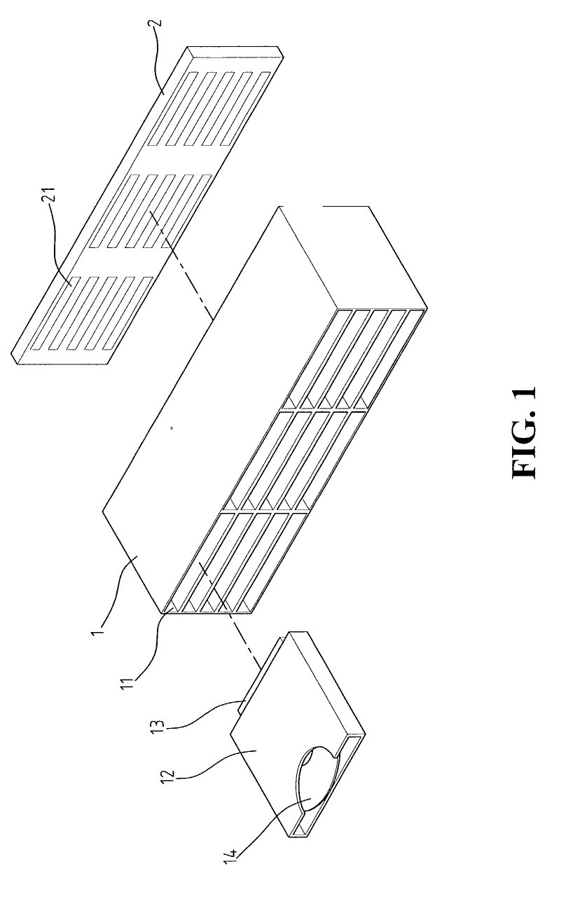

With reference to the drawings and in particular to FIG. 1, a disk organizer constructed in accordance with the present invention comprises a cabinet 1 inside which partitions (not labeled) are mounted to form a number of rows and columns of storage spaces or cells 11 for accommodation of disks 14. Each disk 14 is removably encased in an enclosure 12. A magnet 13 is mounted to an inner end side of the enclosure 12. The enclosure 12 is sized to be completely received in one of the storage spaces 11.

The cabinet 1 comprises a rear board 2 on which a number of drive units 21 which are energizeable to selectively generate magnetism for attracting or expelling the magnet 13 of the enclosure 12 thereby moving the enclosure 12 in and out of the storage space 11. In the embodiment illustrated, the drive units 21 comprise electrically controlled magnetic devices, such as solenoids, which are energizeable to provide magnetic attraction and/or expulsion forces.

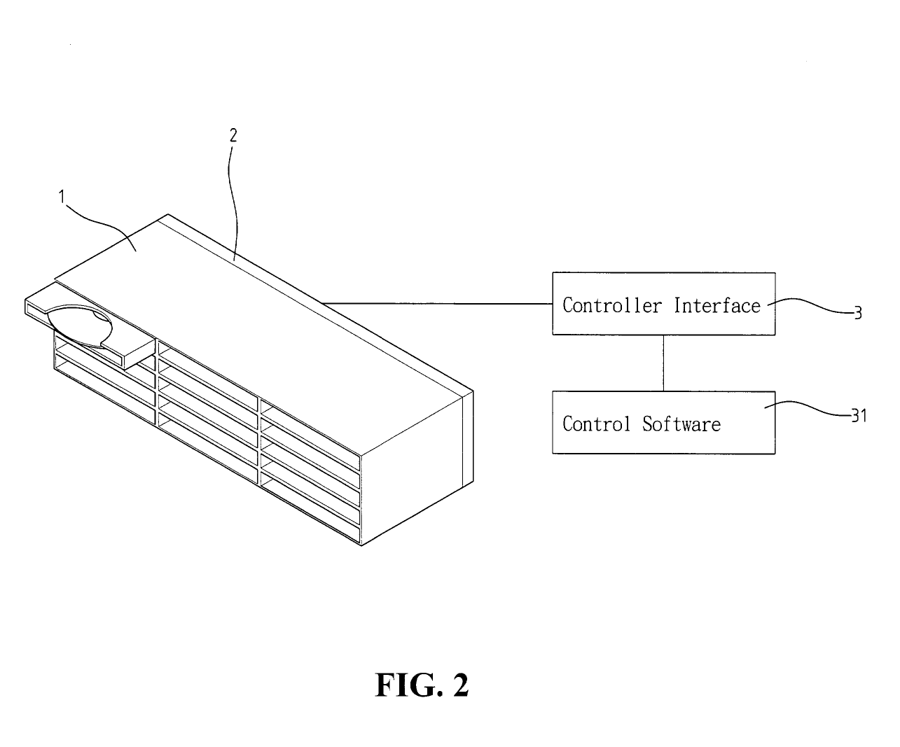

Also referring to FIG. 2, the disk organizer of the present invention is connected to and controlled by a controller system, such as a computer or microprocessor-based control device in which control software 31 is executed to control selective energization of the drive units via a controller interface 3. The controller interface 3 may comprise a user interface, such as a keyboard, a touch panel and a mouse. The user interface provides a user with a tool for disk search and selection. Information and index of the disks that are stored in the cabinet 1 can be recorded in memory of the computer or microprocessor-based device and associated with the storage cells 11 where they are stored. The user can search and select desired disk in the computer or the microprocessor-based device by means of the user interface. Once the selection is done, the computer or microprocessor-based device automatically energizes the drive units 21 of the destination storage cells 11 to move the disk enclosures 12 in and/or out of the cabinet 1.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A disk organizer comprising:
a cabinet defining a number of storage cells each of which is associated with a drive unit;
a disk enclosure receivable in each of the storage cells and adapted to receive and accommodate a disk, a magnet being mounted to the enclosure; and
a controller system selectively energizing the drive unit to generate magnetic attraction and expulsion for the magnet to selectively move and disk enclosure in and out of the associated storage cell of the cabinet.

2. The disk organizer as claimed in claim 1, wherein the drive unit comprises an electrically controlled magnetic device for generating the magnetic attraction and expulsion.

3. The disk organizer as claimed in claim 1, wherein the controller system comprises a microprocessor-based controller connected to and controlling the drive unit.

4. The disk organizer as claimed in claim 3, wherein the microprocessor-based controller comprises a user interface for accessing the disk enclosures via the microprocessor-based controller.

5. The disk organizer as claimed in claim 4, wherein the user interface comprises a keyboard.

6. The disk organizer as claimed in claim 4, wherein the user interface comprises a mouse.

7. The disk organizer as claimed in claim 4, wherein the user interface comprises a touch panel.

8. The disk organizer as claimed in claim 4, wherein information of disks that are encased in the enclosure is stored in the controller system and accessible via a user interface.

9. The disk organizer as claimed in claim 8, wherein the controller system comprises a computer equipped with data storage means.
